(19) United States
(12) Patent Application Publication
(10) Pub. No.: US 2026/0242520 A1
(43) Pub. Date: Aug. 20, 2026

(54) Polyvinyl alcohol-stabilized polyvinyl esters as dispersion adhesives

(71) Applicant: WACKER CHEMIE AG, Munich (DE)

(72) Inventors: Joachim Weihrather, Munich (DE); Stefan Haid, Munich (DE); Julia Hautz, Munich (DE); Stephan Kaiser, Munich (DE); Gerhard Kögler, Munich (DE)

(73) Assignee: WACKER CHEMIE AG, Munich (DE)

(21) Appl. No.: 19/161,395

(22) PCT Filed: Mar. 2, 2023
(86) PCT No.: PCT/EP2023/055382

§ 371 Date: Sep. 2, 2025

(51) Int. Cl. C08F 218/08; B05D 1/02; C08F 2/22; C08K 5/00; C08K 5/103; C09J 131/04

(52) U.S. Cl. CPC C08F 218/08; B05D 1/02; C08F 2/22; C08K 5/0016; C08K 5/103; C09J 131/04

(57) ABSTRACT

Polyvinyl alcohol-stabilized polyvinyl esters are provided in the form of aqueous dispersions. Such polyvinyl esters are described for use as dispersion adhesives, particularly in machine application methods such as nozzle or roll application. The polyvinyl esters are stabilized by at least two polyvinyl alcohols, each with a viscosity of 8-30 mPas and differing viscosities and may be prepared by emulsion polymerization. The dispersion adhesives demonstrate excellent shear stability, wet adhesion, and nozzle running properties, while minimizing adhesive fouling and buildup during high-speed machine application. Such dispersion adhesives are especially suitable for bonding paper, cardboard, and cellulosic materials, including applications requiring food contact.

The invention relates to polyvinyl esters in the form of aqueous dispersions, to processes for their preparation and use in dispersion adhesives, and to processes for applying the dispersion adhesives by machine application methods, in particular production line methods, such as nozzle or roll application methods.

Dispersion adhesives based on polyvinyl esters have a wide range of applications, for example for the adhesive bonding of paper or cardboard packaging for producing folding boxes, envelopes, brochures or cigarettes. Products of this kind are usually produced on an industrial scale in production line manufacturing. In this case, the dispersion adhesives are applied to the substrate generally by machine application methods, such as nozzle application systems or roll technologies. In these application methods, instances of adhesive-related fouling, caused by imprecise or uncontrolled application of adhesive, also referred to as “splashing”, lead to manufacturing problems. If adhesive gets onto the conveyor belt, there may be instances of sticking of the manufactured material, resulting in machine downtime and inconvenient cleaning work. During nozzle application, conical deposits frequently form at the exit point of the nozzle, diverting the jet of adhesive emerging from the nozzle. This is detrimental to precise control of adhesive application and can also lead to contamination and, ultimately, to the shutdown of the apparatus. In nozzle application systems, the dispersion adhesives are supplied by pumps through line systems to a nozzle having a rapidly opening and closing valve, for example with switching frequencies of up to 1000 per second. Such high cycle frequencies of the nozzle valves subject the dispersion adhesives inside the nozzle to extremely high shear forces. Suitable dispersion adhesives must therefore be very shear-stable. In addition, the dispersion adhesives should also have advantageous wet adhesion properties.

Dispersion adhesives for nozzle application systems are described for example in US2008044565. For stabilization, the polymer dispersions of US2008044565 contain compulsorily emulsifiers and optionally protective colloids, without US2008044565 attaching any importance to the configuration of the protective colloids. US2008044565 even points away from protective colloid stabilization. For WO2022/055511 too, it is essential to stabilize the polymer dispersions with emulsifiers. WO2022/055511 also adds polyvinyl alcohol to the emulsifier-stabilized polymer dispersions after they have been prepared by polymerization. US2008039572 also teaches emulsifier-stabilized vinyl acetate-ethylene polymer dispersions for machine application methods.

However, emulsifiers are not tolerated in all applications, such as in contact with food. There is therefore a need for polymer dispersions that are not emulsifier-stabilized, but still meet the requirements for dispersion adhesives for machine application. Polymer dispersions that contain not only medium-viscosity polyvinyl alcohols but also high-viscosity polyvinyl alcohols (36 to 60 mPas) are essential for US20160280974.

Against this background, the object was to provide dispersion adhesives for machine application methods that exhibit very good nozzle running properties and advantageous wet adhesion properties and that contain, as binders, polymer dispersions that are not emulsifier-stabilized.

The invention provides polyvinyl alcohol-stabilized polyvinyl esters in the form of aqueous dispersions, characterized in that the polyvinyl esters are stabilized by at least two polyvinyl alcohols,
where all polyvinyl alcohols have a viscosity from the range of 8 to 30 mPas and at least two polyvinyl alcohols differ in their viscosity,
with the proviso that the polyvinyl alcohol-stabilized polyvinyl esters are not emulsifier-stabilized.

Such polyvinyl alcohol-stabilized polyvinyl esters in the form of aqueous dispersions according to the invention are for example obtainable
by polymerizing a) one or more vinyl esters and optionally b) one or more further ethylenically unsaturated monomers by free-radically initiated emulsion polymerization in aqueous medium in the presence of at least two polyvinyl alcohols in the absence of emulsifiers,
where all polyvinyl alcohols have a viscosity from the range of 8 to 30 mPas and at least two polyvinyl alcohols differ in their viscosity.

The polyvinyl alcohol stabilization is reflected in a structural feature of the polymer dispersion that is not obtained when for example polyvinyl alcohol is subsequently added to an emulsifier-stabilized polymer dispersion, as is known to those skilled in the art in the present technical field. Polyvinyl alcohol-stabilized polyvinyl esters are generally obtained by emulsion polymerization of vinyl esters in the presence of polyvinyl alcohol. In this case, polyvinyl alcohol is generally at least partly grafted, which is not the case when polyvinyl alcohol is subsequently added after the polymerization.

In the present application, the figures for the viscosities of polyvinyl alcohols are based on the Höppler viscosity, in each case determined at 20° C. in accordance with DIN 53015 in 4% aqueous solution.

For clarification, it should be noted that the polyvinyl esters according to the invention are generally not stabilized by polyvinyl alcohols having a viscosity greater than 30 mPas or a viscosity less than 8 mPas.

Preferably, at least one polyvinyl alcohol (polyvinyl alcohol α)) has a viscosity of 8 to 18 mPas, particularly preferably 9 to 17 mPas, and most preferably 11 to 15 mPas.

The proportion of the polyvinyl alcohols α) is preferably 30% to 70% by weight, particularly preferably 40% to 60% by weight and most preferably 45% to 55% by weight, in each case based on the total weight of the polyvinyl alcohols present in the polyvinyl ester dispersion, in particular based on the total weight of the polyvinyl alcohols α) and β).

The proportion of the polyvinyl alcohols α) is preferably 0.5% to 5% by weight, particularly preferably 1% to 3% by weight, most preferably 1.5% to 2.5% by weight, in each case based on the dry weight of the polyvinyl esters.

Preferably, at least one polyvinyl alcohol (polyvinyl alcohol @3)) has a viscosity of 19 to 30 mPas, particularly preferably 20 to 27 mPas, and most preferably 21 to 25 mPas.

The proportion of the polyvinyl alcohols β) is preferably 30% to 70% by weight, particularly preferably 40% to 60% by weight and most preferably 45% to 55% by weight, in each case based on the total weight of the polyvinyl alcohols present in the polyvinyl ester dispersion, in particular based on the total weight of the polyvinyl alcohols α) and β).

The proportion of the polyvinyl alcohols β) is preferably 0.5% to 5% by weight, particularly preferably 1% to 3% by weight, most preferably 1.5% to 2.5% by weight, in each case based on the dry weight of the polyvinyl esters.

The total amount of polyvinyl alcohols, in particular the total amount of polyvinyl alcohols α) and β), is preferably 1% to 10% by weight, more preferably 2% to 6% by weight, particularly preferably 3% to 5% by weight and most preferably 3.5% to 4.5% by weight, in each case based on the dry weight of the polyvinyl esters.

The weight ratio of the polyvinyl alcohols α) to the polyvinyl alcohols β) is preferably in the range of 99:1 to 1:99, particularly preferably 70:30 to 30:70 and most preferably 1:1.5 to 1.5:1.

Preferably, the polyvinyl esters are stabilized with two polyvinyl alcohols, particularly preferably exclusively with one polyvinyl alcohol α) and one polyvinyl alcohol β).

Purely for clarification, it should be noted that polyvinyl alcohols α) and polyvinyl alcohols β) are also referred to jointly as polyvinyl alcohols in the present application.

The polyvinyl alcohols may be partially hydrolyzed or fully hydrolyzed. Preference is given to partially hydrolyzed polyvinyl alcohols. The degree of hydrolysis of the polyvinyl alcohols is preferably 80 to 94 mol %, particularly preferably 83 to 92 mol % and most preferably 85 to 90 mol %.

The polyvinyl alcohols are preferably composed exclusively of vinyl alcohol units and vinyl acetate units. It is alternatively possible to use partially hydrolyzed, hydrophobically modified polyvinyl alcohols, however preference is given to not using any hydrophobically modified polyvinyl alcohols. Examples of these include partially hydrolyzed copolymers of vinyl acetate with hydrophobic comonomers such as isopropenyl acetate, vinyl pivalate, vinyl ethylhexanoate, vinyl esters of saturated alpha-branched monocarboxylic acids having 5 or 9 to 11 carbon atoms, dialkyl maleates and dialkyl fumarates such as diisopropyl maleate and diisopropyl fumarate, vinyl chloride, vinyl alkyl ethers such as vinyl butyl ether, olefins such as ethene and decene. The proportion of the hydrophobic units is preferably 0.1% to 10% by weight, based on the total weight of the partially hydrolyzed polyvinyl alcohol. Mixtures of the polyvinyl alcohols mentioned may also be used. Further preferred polyvinyl alcohols are partially hydrolyzed, hydrophobized polyvinyl alcohols, which are obtained by polymer-analogous reaction, for example acetalization of the vinyl alcohol units with C₁ to C₄ aldehydes such as butyraldehyde. The proportion of the hydrophobic units is preferably 0.1% to 10% by weight, based on the total weight of the partially hydrolyzed polyvinyl acetate. The polyvinyl alcohols mentioned are obtainable by processes known to those skilled in the art.

The polyvinyl esters are generally based on a) one or more vinyl esters and optionally b) one or more further ethylenically unsaturated monomers.

Suitable vinyl esters a) are for example those of carboxylic acids having 1 to 22 carbon atoms, in particular 1 to 12 carbon atoms. Preference is given to vinyl acetate, vinyl propionate, vinyl butyrate, vinyl 2-ethylhexanoate, vinyl laurate, 1-methylvinyl acetate, vinyl pivalate and vinyl esters of α-branched monocarboxylic acids having 9 to 11 carbon atoms, for example VeoVa9R or VeoVa10R (trade names of Momentive). Particular preference is given to vinyl acetate.

The vinyl esters a) are used in an amount of preferably 50% to 100% by weight, particularly preferably 60% to 95% by weight and most preferably 65% to 80% by weight, in each case based on the total weight of the monomers.

One or more olefins, such as propylene or preferably ethylene, are in particular selected as further ethylenically unsaturated monomers b1).

The monomers b1) are copolymerized in an amount of preferably 5% to 40% by weight, particularly preferably 10% to 30% by weight and most preferably 20% to 35% by weight, in each case based on the total weight of the monomers.

As further ethylenically unsaturated monomers b2), it is also possible, optionally in combination with one or more olefins, such as ethylene, for one or more ethylenically unsaturated monomers to be selected from the group comprising (meth)acrylic esters, vinylaromatics, 1,3-dienes and vinyl halides.

Suitable monomers from the group of the esters of acrylic acid or methacrylic acid are for example esters of unbranched or branched alcohols having 1 to 15 carbon atoms. Preferred methacrylic esters or acrylic esters are methyl acrylate, methyl methacrylate, ethyl acrylate, ethyl methacrylate, propyl acrylate, propyl methacrylate, n-butyl acrylate, n-butyl methacrylate and 2-ethylhexyl acrylate. Particular preference is given to methyl acrylate, methyl methacrylate, n-butyl acrylate and 2-ethylhexyl acrylate.

Preferred vinylaromatics are styrene, methylstyrene and vinyltoluene. A preferred vinyl halide is vinyl chloride. The preferred dienes are 1,3-butadiene and isoprene.

The monomers b2) are copolymerized in an amount of preferably 0% to 45% by weight and particularly preferably 10% to 30% by weight, in each case based on the total weight of the monomers. Most preferably, no monomers b2) are copolymerized.

It is optionally also possible to copolymerize 0% to 10% by weight, in particular 0.05% to 10% by weight, based on the total weight of the monomer mixture, of auxiliary monomers. Most preferably, however, no auxiliary monomers are copolymerized. Examples of auxiliary monomers are ethylenically unsaturated mono- and dicarboxylic acids, preferably acrylic acid, methacrylic acid, fumaric acid and maleic acid; ethylenically unsaturated carboxamides and carbonitriles, preferably acrylamide and acrylonitrile; mono- and diesters of fumaric acid and maleic acid such as the diethyl and diisopropyl esters, and maleic anhydride, ethylenically unsaturated sulfonic acids or salts thereof, preferably vinylsulfonic acid, and 2-acrylamido-2-methylpropanesulfonic acid. Further examples are precrosslinking comonomers such as polyethylenically unsaturated comonomers, for example divinyl adipate, diallyl maleate, allyl methacrylate, triallyl isocyanurate or triallyl cyanurate, or postcrosslinking comonomers, for example acrylamidoglycolic acid (AGA), methylacrylamidoglycolic acid methyl ester (MAGME), N-methylolacrylamide (NMA), N-methylolmethacrylamide, N-methylolallyl carbamate, alkyl ethers such as the isobutoxy ether or ester of N-methylolacrylamide, of N-methylolmethacrylamide and of N-methylolallyl carbamate. Also suitable are epoxy-functional comonomers such as glycidyl methacrylate and glycidyl acrylate. Further examples are silicon-functional comonomers, such as acryloyloxypropyltri(alkoxy)- and methacryloyloxypropyltri(alkoxy)silanes, vinyltrialkoxysilanes, and vinylmethyldialkoxysilanes, where the alkoxy groups present may for example be ethoxy and ethoxypropylene glycol ether radicals. Mention should also be made of monomers having hydroxy or CO groups, for example hydroxyalkyl methacrylates and acrylates such as hydroxyethyl, hydroxypropyl or hydroxybutyl acrylate or methacrylate, and compounds such as diacetone acrylamide and acetylacetoxyethyl acrylate or methacrylate.

Preferably, one or more polyvinyl esters are selected from the group comprising vinyl ester homopolymers, vinyl ester-ethylene copolymers, vinyl ester copolymers containing one or more vinyl ester units and one or more further monomer units from the group comprising vinylaromatics, vinyl halides, acrylic esters, methacrylic esters, and optionally ethylene.

Examples of preferred vinyl ester copolymers are based on 50% to 90% by weight of one or more vinyl esters, 10% to 20% by weight of ethylene and optionally 1% to 40% by weight of one or more further monomers, based on the total weight of the monomers.

Preference is also given to comonomer mixtures of vinyl acetate with 10% to 20% by weight of ethylene; and comonomer mixtures of vinyl acetate with 10% to 20% by weight of ethylene and 1% to 40% by weight of one or more further comonomers from the group of vinyl esters having 1 to 12 carbon atoms in the carboxyl radical such as vinyl propionate, vinyl laurate, vinyl esters of alpha-branched carboxylic acids having 9 to 11 carbon atoms such as VeoVa9, VeoVa10, VeoVa11; and mixtures of vinyl acetate, 10% to 20% by weight of ethylene and preferably 1% to 40% by weight of acrylic esters of unbranched or branched alcohols having 1 to 15 carbon atoms, in particular n-butyl acrylate or 2-ethylhexyl acrylate; and mixtures with 30% to 75% by weight of vinyl acetate, 1% to 30% by weight of vinyl laurate or vinyl esters of an alpha-branched carboxylic acid having 9 to 11 carbon atoms, and 1% to 30% by weight of acrylic esters of unbranched or branched alcohols having 1 to 15 carbon atoms, in particular n-butyl acrylate or 2-ethylhexyl acrylate, which also contain 10% to 20% by weight of ethylene; and mixtures with vinyl acetate, 10% to 20% by weight of ethylene and 1% to 60% by weight of vinyl chloride; where the mixtures may also contain the auxiliary monomers mentioned in the amounts mentioned, and the figures in % by weight add up to 100% by weight in each case.

The polyvinyl esters are preferably bimodal or multimodal. The polyvinyl esters in the form of aqueous dispersions, at a solids content of 53% in water, have a viscosity of preferably 4000 to 12 000 mPas, particularly preferably 5000 to 10 000 mPas and most preferably 7000 to 8000 mPas (determined with a Brookfield viscometer, at 23° C. and 20 rpm, using the spindle usually used by those skilled in the art for the respective viscosity range).

The polyvinyl esters have weight-average particle diameters Dw of preferably 500 nm to 15 μm, particularly preferably 1 μm to 12 μm and most preferably 1 μm to 5 μm (determined by means of static light scattering using the LS 13320 measuring device from BeckmanCoulter).

The polyvinyl esters have a polydispersity PD of preferably ≥2, more preferably 2 to 30, particularly preferably 2.5 to 5. The polydispersity PD is known to stand for the ratio of weight-average particle diameter Dw to number-average particle diameter Dn, PD=Dw/Dn (determination by means of static light scattering using the LS 13320 measuring device from BeckmanCoulter). The polyvinyl esters are preferably bimodal or multimodal.

The polyvinyl esters have glass transition temperatures Tg of preferably −30° C. to +40° C., more preferably −20° C. to +20° C., particularly preferably of −15° C. to +10° C. and most preferably of −10° C. to 0° C. The monomer selection and the selection of the proportions by weight of the comonomers is made so as to result in the aforementioned glass transition temperatures Tg. The glass transition temperature Tg of the polymers is determined using the Mettler-Toledo DSC1 dynamic scanning calorimeter in a closed crucible at a heating rate of 10 K/min. The midpoint of the glass transition during the 2^{nd} heating cycle is evaluated. An approximate Tg can also be precalculated by means of the Fox equation. According to Fox T. G., Bull. Am. Physics Soc. 1, 3, page 123 (1956): 1/Tg=x₁/Tg₁+x₂/Tg₂+ . . . +xₙ/Tgₙ, where xₙ is the mass fraction (% by weight/100) of the monomer n, and Tgₙ is the glass transition temperature in kelvin of the homopolymer of the monomer n. Tg values for homopolymers are listed in Polymer Handbook 2nd Edition, J. Wiley & Sons, New York (1975).

The polyvinyl esters preferably exhibit only one glass transition temperature Tg. The polyvinyl esters are preferably homogeneous and particularly preferably non-heterophasic.

The invention further provides processes for preparing polyvinyl esters in the form of aqueous dispersions by free-radically initiated emulsion polymerization of a) one or more vinyl esters and optionally b) one or more further ethylenically unsaturated monomers in aqueous medium in the presence of at least two polyvinyl alcohols in the absence of emulsifiers, characterized in that all polyvinyl alcohols have a viscosity from the range of 8 to 30 mPas and at least two polyvinyl alcohols differ in their viscosity.

The emulsion polymerization is usually performed in aqueous medium, i.e. usually in the absence of organic solvents. In the copolymerization of gaseous comonomers such as ethylene, 1,3-butadiene or vinyl chloride, it is also possible to work under pressure, generally between 5 bar and 120 bar, preferably between 65 and 80 bar. The polymerization temperature is generally 40° C. to 120° C., preferably 50° C. to 80° C. and particularly preferably 70° C. to 80° C.

The polymerization is preferably initiated with the redox initiator combinations that are commonly used for emulsion polymerization. Examples of suitable oxidation initiators are the sodium, potassium and ammonium salts of peroxodisulfuric acid, hydrogen peroxide, t-butyl peroxide, t-butyl hydroperoxide, potassium peroxodiphosphate, tert-butyl peroxopivalate, cumene hydroperoxide, isopropylbenzene monohydroperoxide, azobisisobutyronitrile. Particular preference is given to the sodium, potassium and ammonium salts of peroxodisulfuric acid and hydrogen peroxide. The initiators mentioned are generally used in an amount of 0.01% to 2.0% by weight, based on the total weight of the monomers. The oxidizing agents mentioned, in particular the salts of peroxodisulfuric acid, may also be used alone as thermal initiators.

Suitable reducing agents are for example the sulfites and bisulfites of alkali metals and of ammonium, such as sodium sulfite, the derivatives of sulfoxylic acid such as zinc or alkali metal formaldehyde sulfoxylates, for example sodium hydroxymethanesulfinate (Bruggolite), (iso)ascorbic acid or salts thereof, and mixtures of the salts of 2-hydroxy-2-sulfinatoacetic acid and 2-hydroxy 2-sulfonatoacetic acid with sodium sulfite (FF6). Preference is given to sodium sulfite, sodium bisulfite and in particular (iso)ascorbic acid or the alkali(ne earth) metal salts thereof and FF6. The amount of reducing agent is preferably 0.015% to 3% by weight, based on the total weight of the monomers.

The polymerization is usually carried out at pHs of ≥9, preferably 2 to 9 and particularly preferably 3 to 8. The pH may be adjusted using the standard measures, such as acids, bases or in particular buffers, such as sodium acetate or phosphates.

Substances that act as chain-transfer agents may be used during the polymerization to control the molecular weight. If chain-transfer agents are used, they are usually used in amounts between 0.01% and 5.0% by weight, based on the total weight of the monomers to be polymerized, and are metered in separately or else having been premixed with reaction components. Examples of such substances are n-dodecyl mercaptan, tert-dodecyl mercaptan, mercaptopropionic acid, methyl mercaptopropionate, isopropanol and acetaldehyde. Preference is given to using no substances that act as chain-transfer agents.

The polymerization is performed in the presence of the polyvinyl alcohols mentioned at the outset and optionally one or more further protective colloids. However, further protective colloids are preferably dispensed with. The dispersion adhesives or the polyvinyl esters in the form of aqueous dispersions thus preferably do not contain any further protective colloids in addition to polyvinyl alcohols. Examples of further protective colloids are polyvinylpyrrolidones; polysaccharides in water-soluble form such as starches (amylose and amylopectin), celluloses and the carboxymethyl, methyl, hydroxyethyl and hydroxypropyl derivatives thereof; proteins such as casein or caseinate, soy protein, gelatin; lignosulfonates; synthetic polymers such as poly(meth)acrylic acid, copolymers of (meth)acrylates with carboxy-functional comonomer units, poly(meth)acrylamide, polyvinylsulfonic acids and the water-soluble copolymers thereof; melamine-formaldehydesulfonates, naphthalene-formaldehydesulfonates, styrene-maleic acid copolymers and vinyl ether-maleic acid copolymers.

The polyvinyl alcohols and the optionally used further protective colloids are altogether generally added in the emulsion polymerization in a total amount of 0.5% to 20% by weight, based on the total weight of the monomers.

The emulsion polymerization is performed in the absence of emulsifiers. Examples of emulsifiers are given hereinbelow.

The polymerization may be carried out in conventional polymerization reactors, for example in pressure reactors and/or unpressurized reactors. As pressure reactors or unpressurized reactors, it is possible to use the conventional, correspondingly dimensioned steel reactors with stirring device, heating/cooling systems, and lines for supplying the reactants and removing the products, respectively. When gaseous monomers are used, such as ethylene, preference is given to using a pressure reactor and optionally additionally an unpressurized reactor. The preferred operating pressure in the pressure reactor is 3 to 120 bar, particularly preferably 10 to 80 bar. The preferred operating pressure in the unpressurized reactor is 100 mbar to 5 bar, particularly preferably 200 mbar to 1 bar.

The polymerization is preferably carried out in a batch or semibatch process, but may also be performed in a continuous process.

In a batch or semibatch process, the monomers may for example be metered in or initially charged in their entirety. A preferred procedure is to initially charge 20% to 100% by weight, in particular 30% to 60% by weight, based on the total weight, of the monomers and to meter in the remaining amount of monomers at a later point in time during the emulsion polymerization. The metered additions may be carried out separately (in terms of location and time), or some or all of the components to be metered in may be metered in in pre-emulsified form.

The polyvinyl alcohols and the optionally used further protective colloids may for example be initially charged in their entirety or partly metered in. Preference is given to initially charging at least 25% by weight, particularly preferably at least 70% by weight, of the polyvinyl alcohols and of any further protective colloids, in each case based on the total amount used of polyvinyl alcohols and, where present, of further protective colloids. Most preferably, the polyvinyl alcohols and any further protective colloids are initially charged in their entirety.

The initiators may for example be either initially charged in their entirety or partly metered in. Preferably, the initiators are metered in in their entirety.

On conclusion of the polymerization, a post-polymerization is also preferably carried out. In the post-polymerization, remaining amounts of residual monomer are polymerized. The post-polymerization is performed using known methods, generally with redox catalyst-initiated post-polymerization.

Volatile compounds, such as residual monomer or impurities from initiator components or other raw materials, may also be removed by distillation or stripping from the aqueous dispersion. In the case of stripping, optionally under reduced pressure, volatile compounds are removed from the dispersions while passing inert entraining gases, such as air, nitrogen or water vapor, through or over the mixture.

The polyvinyl esters in the form of aqueous dispersions have a solids content of preferably 30% to 75% by weight, particularly preferably 50% to 60% by weight.

In one embodiment, the aqueous dispersions of the polyvinyl alcohol-stabilized polyvinyl esters do not contain any emulsifiers.

In an alternative process for preparing aqueous polyvinyl ester dispersions, one or more emulsifiers are added after the emulsion polymerization.

The invention further provides processes for preparing polyvinyl esters in the form of aqueous dispersions by free-radically initiated emulsion polymerization of a) one or more vinyl esters and optionally b) one or more further ethylenically unsaturated monomers in aqueous medium in the presence of at least two polyvinyl alcohols in the absence of emulsifiers, characterized in that
all polyvinyl alcohols have a viscosity from the range of 8 to 30 mPas and at least two polyvinyl alcohols differ in their viscosity and
one or more emulsifiers are added after the emulsion polymerization has been carried out.

The invention further provides polyvinyl alcohol-stabilized polyvinyl esters in the form of aqueous dispersions obtainable by free-radically initiated emulsion polymerization of a) one or more vinyl esters and optionally b) one or more further ethylenically unsaturated monomers in aqueous medium in the presence of at least two polyvinyl alcohols in the absence of emulsifiers, characterized in that
all polyvinyl alcohols have a viscosity from the range of 8 to 30 mPas and at least two polyvinyl alcohols differ in their viscosity and
one or more emulsifiers are added after the emulsion polymerization has been carried out (post-addition).

The emulsifiers are thus added after the emulsion polymerization has been carried out, that is to say for example at a degree of conversion of all of the monomers used, in particular of all of the vinyl esters used, of ≥95%, in particular ≥97%. The degree of conversion of the monomers may be determined for example by ¹H NMR spectroscopy, preferably on the basis of the vinyl esters, particularly preferably on the basis of vinyl acetate. The post-addition of the emulsifiers is performed for example after all the initiator amounts for the emulsion polymerization have been added. The post-addition of the emulsifiers is preferably carried out after the post-polymerization.

Examples of emulsifiers are anionic, cationic or nonionic or amphoteric emulsifiers.

Examples of anionic emulsifiers are alkyl sulfates having a chain length of 8 to 18 carbon atoms, alkyl or alkylaryl ether sulfates having 8 to 18 carbon atoms in the hydrophobic radical and up to 40 ethylene oxide or propylene oxide units, alkyl or alkylaryl sulfonates having 8 to 18 carbon atoms, esters and monoesters of sulfosuccinic acid with monohydric alcohols or alkylphenols.

Examples of nonionic emulsifiers are alkyl polyglycol ethers having 8 to 40 ethylene oxide units or preferably gemini surfactants.

Preferred gemini surfactants are alkyne derivatives containing two alcohol groups. Particularly preferred gemini surfactants are alkynediol derivatives in which one or in particular both of the alcohol groups are substituted by polyethylene glycol radicals, for example by polyethylene glycol chains having 1 to 50 ethylene glycol units. Particularly preferred gemini surfactants also include reaction products of epoxides with alkynediol derivatives where one or both of the alcohol groups of the alkynediol derivatives may have been transformed with epoxides.

Examples of amphoteric emulsifiers are betaines such as coco-dipropionate and salts thereof, 2-ethylhexyl dipropionate and salts thereof, cocoamphodipropionate and salts thereof, sultaines such as cocamidopropyl hydroxysultaine and salts thereof, and amino acids and salts thereof. Disodium 2-ethylhexyl dipropionate is particularly preferred as amphoteric emulsifier.

Preferably up to 5% by weight, particularly preferably 0.05% up to 2% by weight and most preferably 0.1% to 1% by weight of emulsifiers, based on the dry weight of the polyvinyl esters, is introduced by post-addition.

Any emulsifiers are preferably introduced into the polyvinyl ester dispersions exclusively by post-addition.

Preferably no protective colloids, particularly preferably no polyvinyl alcohols and most preferably no polyvinyl alcohols with the viscosity according to the invention are introduced into the polyvinyl ester dispersions by post-addition. Alternatively, although less preferred, protective colloids, in particular polyvinyl alcohols, may also be introduced into the polyvinyl ester dispersions by post-addition. Preferably ≥5% by weight, more preferably ≥0.9% by weight and even more preferably ≥0.4% by weight of protective colloids, in particular polyvinyl alcohol, is introduced by post-addition, based on the dry weight of the polyvinyl esters. Preferably ≥5% by weight, more preferably ≥0.9% by weight and even more preferably ≥0.4% by weight of protective colloids, in particular polyvinyl alcohol, is introduced by post-addition, based on the total weight of the polyvinyl alcohols present in the polyvinyl ester dispersions.

The invention further provides dispersion adhesives containing one or more polyvinyl alcohol-stabilized polyvinyl esters, one or more additives and water, characterized in that the polyvinyl alcohol-stabilized polyvinyl esters are obtainable by free-radically initiated emulsion polymerization of a) one or more vinyl esters and optionally b) one or more further ethylenically unsaturated monomers in aqueous medium in the presence of at least two polyvinyl alcohols in the absence of emulsifiers,
where all polyvinyl alcohols of the polyvinyl alcohol-stabilized polyvinyl esters have a viscosity from the range of 8 to 30 mPas and at least two polyvinyl alcohols differ in their viscosity and
optionally one or more emulsifiers are added after the emulsion polymerization has been carried out (post-addition).

The dispersion adhesives contain preferably at least 40% by weight, particularly preferably at least 50% by weight and most preferably at least 60% by weight of polyvinyl esters. The dispersion adhesives contain preferably at most 99% by weight and particularly preferably at most 95% by weight of polyvinyl esters. The figures in % by weight are based in each case on the dry weight of the dispersion adhesives.

Optionally, the dispersion adhesives also contain one or more additives, for example plasticizers, such as phthalates, benzoates or adipates, film-forming aids, such as triacetin or glycols, in particular butyl glycol, butyl diglycol, butyl dipropylene glycol and butyl tripropylene glycol, wetting agents, generally surfactants, thickeners such as polyacrylates, polyurethanes, cellulose ethers or polyvinyl alcohols, defoamers, tackifiers or other additives that are customary for the formulation of adhesives. The proportion of these additives may for example be up to 40% by weight, preferably 0% to 25% by weight, more preferably 1% to 15% by weight, particularly preferably 1% to 10% by weight and most preferably 1% to 5% by weight, each based on the dry weight of the dispersion adhesives.

The dispersion adhesives have a solids content of preferably 30% to 75% by weight, particularly preferably 50% to 60% by weight. The remaining proportions are preferably water. The amounts of solids and water amount in total to 100% by weight.

The dispersion adhesives may be prepared by the standard processes for this purpose, generally by mixing the aforementioned components. The mixing may be performed in conventional mixers, such as stirrers or dissolvers. The mixing is preferably performed at temperatures of 5° C. to 50° C., particularly preferably 15° C. to 40° C. and most preferably 20° C. to 30° C.

The invention further provides processes for applying dispersion adhesives according to the invention by machine application methods.

The dispersion adhesives according to the invention may be used in the standard machine application methods for dispersion adhesives, such as in nozzle or roll application methods. The dispersion adhesives in this case are applied to substrates. The application may be performed continuously, in lines, or dotwise. In this case, the dispersion adhesives according to the invention are suitable for the adhesive bonding of a variety of substrates, preferably paper, paperboard, wood, fiber materials, coated cardboard, and for the adhesive bonding of cellulosic materials to plastics, such as polymeric films, for example polyethylene, polyvinyl chloride, polyamide, polyester or polystyrene films. The dispersion adhesives are in particular used as paper adhesives, packaging adhesives, wood adhesives and bonding agents for woven and non-woven fiber materials. The dispersion adhesives are particularly suitable for the adhesive bonding of cellulosic substrates, in particular paper, paperboard or cotton fabric, in each case to polymeric films, or for the adhesive bonding of polymeric films to one another (film/film bonding).

The dispersion adhesives according to the invention are ideally suitable for application by machine application methods. For example, the incidence of unwanted depositions of adhesive on the application nozzle or of uncontrolled “splashes” can be avoided to the desired extent with the dispersion adhesives according to the invention. The dispersion adhesives exhibit advantageous rheological properties, such as low shear thinning. The dispersion adhesives according to the invention also make it possible to achieve the rapid setting speed required in the case of machine methods. The dispersion adhesives are also storage-stable and have advantageous wet adhesion properties.

It was also surprising that, in the procedure according to the invention, the addition of emulsifiers to the dispersion adhesives or polyvinyl ester dispersions can be dispensed with, and the dispersion adhesives according to the invention can still be applied by machine and lead to the desired performance properties. This also enables the use of the polyvinyl ester dispersions in applications in contact with food, in which emulsifier-containing dispersion adhesives are problematic or not permitted.

Subsequent addition of emulsifiers, in particular amphoteric emulsifiers, to the polymer dispersions, that is to say addition of emulsifiers after the polymerization, makes it possible to further reduce depositions on the application nozzle in the case of machine application of the dispersion adhesives.

The examples that follow serve for further elucidation of the invention.

The Höppler viscosities reported below for polyvinyl alcohols were determined at 20° C. in 4% aqueous solution in accordance with DIN 53015. The Brookfield viscosities (BF20) of the aqueous polyvinyl ester dispersions were determined at the respectively reported solids content at 23° C. with a Brookfield viscometer at 20 rpm.

### EXAMPLE 1 (EX. 1)

A pressure reactor with a volume of 600 liters was initially charged with the following components:
122 kg of water,
58 kg of a 10% aqueous solution of the polyvinyl alcohol with a degree of hydrolysis of 88% and a Höppler viscosity of 23 mPas for a 4% aqueous solution (523),
58 kg of a 10% aqueous solution of the polyvinyl alcohol with a degree of hydrolysis of 88% and a Höppler viscosity of 13 mPas for a 4% aqueous solution (513),
200 g of 98% strength formic acid,
142 g of iron(II) ammonium sulfate solution (10% in water).

The pressure reactor was evacuated and then 91 kg of vinyl acetate was added to the initial charge. Thereafter, the reactor was heated to 50° C. and subjected to an ethylene pressure of 45 bar (corresponding to an amount of 34 kg of ethylene).

The polymerization was started by starting the metered addition of a 3% aqueous hydrogen peroxide solution at a rate of 443 g/h and of a 10% aqueous Bruggolite FF6 solution at a rate of 443 g/h. With the start of polymerization, the temperature was increased from 50° C. to 75° C. 10 minutes after the start of polymerization, vinyl acetate was metered in at a rate of 60 kg/h for 2 hours and ethylene was metered in at a rate of 18 kg/h for 2 hours.

After the end of the vinyl acetate metered addition, the metered additions of the hydrogen peroxide solution and of the Bruggolite FF6 solution were continued for a further 60 minutes. The total polymerization time was 3.5 hours.

The thus obtained polymer dispersion was subsequently transferred into an unpressurized reactor. A pressure of 0.7 mbar was applied to the unpressurized reactor. 2.2 kg of a 10% aqueous tert-butyl hydroperoxide solution and 1.6 kg of an aqueous 10% Bruggolite FF6 solution were added to the unpressurized reactor, and post-polymerization was carried out. The pH was adjusted to 4.5 by addition of aqueous sodium hydroxide solution (10% strength). Finally, the batch was filtered using a sieve having a mesh size of 150 μm.

The properties of the polymer dispersion are listed in Table 1.

### COMPARATIVE EXAMPLE 1 (COMP. EX. 1)

The polymerization was performed analogously to Example 1, with the difference that instead of the polyvinyl alcohol with a viscosity of 13 mPas (513), 58 kg of a 10% aqueous solution of a polyvinyl alcohol (05/88) with a degree of hydrolysis of 88% and a Höppler viscosity of 5 mPas for a 4% aqueous solution was used.

The properties of the polymer dispersion are listed in Table 1.

### COMPARATIVE EXAMPLE 2 (COMP. EX. 2)

The polymerization was performed analogously to Example 1, with the difference that 12 kg of a 10% aqueous solution of a third polyvinyl alcohol with a Höppler viscosity (4% in aqueous solution) of 5 mPas (05/88) was additionally used.

The properties of the polymer dispersion are listed in Table 1.

### COMPARATIVE EXAMPLE 3 (COMP. EX. 3)

Aqueous dispersion of a vinyl acetate-ethylene copolymer prepared according to Example 2 of DE102006037318.

The properties of the polymer dispersion are listed in Table 1.

### COMPARATIVE EXAMPLE 4 (COMP. EX. 4)

Aqueous dispersion of a polyvinyl alcohol-stabilized vinyl acetate-ethylene copolymer prepared according to Example 2 of DE102013226114, that is to say the polyvinyl alcohol stabilization was performed by way of three different polyvinyl alcohols with a viscosity of 5 mPas, 23 mPas and 40 mPas, respectively.

The properties of the polymer dispersion are listed in Table 1.

### COMPARATIVE EXAMPLE 5 (COMP. EX. 5)

Aqueous dispersion of a purely emulsifier-stabilized vinyl acetate-ethylene copolymer prepared according to Example 4b of WO2022/055511 with post-addition of polyvinyl alcohol.

The properties of the polymer dispersion are listed in Table 1.

### COMPARATIVE EXAMPLE 6 (COMP. EX. 6)

Commercially available vinyl acetate-ethylene dispersion stabilized with polyvinyl alcohol and emulsifier. The dispersion had a solids content of 53.5%, a Brookfield viscosity of 7600 mPas and a glass transition temperature Tg of −7° C.

### EXAMPLE 2 (EX. 2)

After the polymerization, 0.25%, based on the total dispersion, of the gemini surfactant Surfynol 465 (trade name of Evonik Industries AG) was added to the polymer dispersion from Example 1 by post-addition.

The properties of the polymer dispersion are listed in Table 1.

TABLE 1
Properties of polymer dispersions:

| | Polyvinyl alcohol | | | | | | | | |
|---|---|---|---|---|---|---|---|---|---|
| | in initial charge [% by | | | | Emulsifier | | | Emulsifier | |
| | weight] ^{e)} | | | | in initial | SC ^{f)} | BF20 ^{g)} | post- | Tg ^{h)} |
| | 05/88^{a)} | 513^{b)} | 523^{c)} | 50/88^{d)} | charge | [%] | [mPas] | addition | [° C.] |
| Ex. 1 | — | 1.0 | 1.0 | — | − | 53.3 | 5080 | − | −8 |
| Comp. | 1.0 | — | 1.0 | — | − | 52.8 | 5600 | − | −8 |
| Ex. 1 | | | | | | | | | |
| Comp. | 0.2 | 1.0 | 1.0 | — | − | 53.3 | 7560 | − | −8 |
| Ex. 2 | | | | | | | | | |
| Comp. | — | — | 0.3 | — | + | 54.4 | 6400 | − | 4 |
| Ex. 3 | | | | | | | | | |
| Comp. | 1.0 | — | 1.4 | 0.1 | − | 54.4 | 12540 | − | 0 |
| Ex. 4 | | | | | | | | | |
| Comp. | — | — | — | — | + | 47.1 | 3600 | − | −8 |
| Ex. 5 | | | | | | | | | |
| Ex. 2 | — | 1.0 | 1.0 | — | − | 53.2 | 5000 | + | −8 |
| Ex. 3 | — | 1.0 | 1.0 | — | − | 53.0 | 4830 | + | −8 |

^{a)}Polyvinyl alcohol with a degree of hydrolysis of 88 mol % and a Höppler viscosity of 5 mPas;
^{b)}Polyvinyl alcohol with a degree of hydrolysis of 88 mol % and a Höppler viscosity of 13 mPas;
^{c)}Polyvinyl alcohol with a degree of hydrolysis of 88 mol % and a Höppler viscosity of 23 mPas;
^{d)}Polyvinyl alcohol with a degree of hydrolysis of 88 mol % and a Höppler viscosity of 50 mPas;
^{e)} Figures in % by weight are based on the total dispersion;
^{f)} SC = solids content;
^{g)} BF20 = Brookfield viscosity;
^{h)} Tg = glass transition temperature

### EXAMPLE 3 (EX. 3)

After the polymerization, 0.20%, based on the total dispersion, of the amphoteric emulsifier sodium N-(2-carboxyethyl)-N-(2-ethylhexyl)-ß-alaninate (Librateric BA-40, trade name of Libra Specialty Chemicals LTD) was added to the polymer dispersion from Example 1 by post-addition. The properties of the polymer dispersion are listed in Table 1.

### Nozzle Application Method: Determination of Web Buildup:

The dispersion adhesives were applied by nozzle application to a rotating stainless steel roll. The stainless steel roll had a circumference of 80 cm and rotated about its own axis at a speed of 120 or 140 revolutions/min (rpm). The dispersion adhesives were applied using an HHS application system with valves of type GKD4-114-2m and nozzles of type LVK-4. The nozzles were mounted perpendicularly above the roll surface at a distance of 4 mm. The dispersion adhesives were adjusted to a viscosity of 800 mPas by dilution with water and were supplied to the nozzles via hose lines by means of a piston pump using a pressure of 9 bar. The application of the dispersion adhesives through the nozzles onto the stainless steel roll was pulsed, by the nozzles being opened and closed again at a constant rate. One cycle of single opening and closing of the nozzle is referred to as a pulse. 18 pulses of the nozzle per rotation of the stainless steel roll were set. The dispersion adhesives were immediately scraped from the stainless steel roll with a plastic scraper. Testing was performed under standard conditions at 23° C. and a relative humidity of 50%.

120 minutes after the beginning of nozzle application, the size of the conical buildup (web buildup) on the nozzle was measured. The results of the testing are listed in Table 2.

If the conical buildup almost reached the surface of the roll before 120 minutes had elapsed, testing was discontinued and the measurement value reported was >4 mm.

### Determination of the Manual Setting Speed:

A cardboard (for example Zenith ZENP235 (235 g/m²)) was cut to a length of 45 cm and a width of 10 cm. The coated side of the cardboard was provided with a cm scale. The adhesive (50 μm wet film thickness) was applied using a slotted doctor blade.

Immediately afterward, a paper strip (for example Varitess 290.150 (150 g/m²) from Lahnstein; length 55 cm and width 5 cm) was placed on the adhesive film and bonded using a hand roller. The removal of the paper strip was immediately started (by hand at a speed of 1 cm/s). When a significant fiber tear occurred, the distance traveled up to the fiber tear was correlated with time (1 cm distance corresponds to 1 s). This value indicated the setting time of the adhesive and is reported in Table 2 for the respective example.

TABLE 2
Results of the testing:

| | | | Particle size | |
|---|---|---|---|---|
| | Web buildup | Manual setting | distribution | |
| Dispersion | [mm] | speed [s] | Dw [μm] | Dw/Dn |
| Ex. 1 | 3.0 | 18 | 2.6 | 3.6 |
| Comp. Ex. | >4.0 | 19 | 2.5 | 4.5 |
| 1 | | | | |
| Comp. Ex. | >4.0 | 20 | 2.5 | 4.3 |
| 2 | | | | |
| Comp. Ex. | 4.0 | 20 | 0.5 | 2.0 |
| 3 | | | | |
| Comp. Ex. | >4.0 | 19 | 1.4 | 1.7 |
| 4 | | | | |
| Comp. Ex. | >4.0 | 24 | 0.2 | 3.5 |
| 5 | | | | |
| Comp. Ex. | 4.0 | 21 | 1.8 | 3.0 |
| 6 | | | | |
| Ex. 2 | 2.5 | 14 | 2.6 | 3.6 |
| Ex. 3 | 0.0 | 18 | 2.6 | 3.6 |

1-15. (canceled)

16. Polyvinyl alcohol-stabilized polyvinyl esters in the form of aqueous dispersions, characterized in that the polyvinyl esters are stabilized by at least two polyvinyl alcohols,
where all polyvinyl alcohols have a degree of hydrolysis of 80 to 94 mol % and a viscosity from the range of 8 to 30 mPas and at least two polyvinyl alcohols differ in their viscosity,
where the viscosity of the polyvinyl alcohols is determined at 20° C. in 4% aqueous solution according to Höppler in accordance with DIN 53015,
with the proviso that the polyvinyl alcohol-stabilized polyvinyl esters are not emulsifier-stabilized and
the aqueous dispersions of the polyvinyl alcohol-stabilized polyvinyl esters do not contain any emulsifiers.

17. The polyvinyl alcohol-stabilized polyvinyl esters in the form of aqueous dispersions as claimed in claim 16, characterized in that at least one polyvinyl alcohol (polyvinyl alcohol α)) has a viscosity of 8 to 18 mPas.

18. The polyvinyl alcohol-stabilized polyvinyl esters in the form of aqueous dispersions as claimed in claim 17, characterized in that the proportion of the polyvinyl alcohols α) is 30% to 70% by weight, based on the total weight of the polyvinyl alcohols present in the polyvinyl ester dispersion.

19. The polyvinyl alcohol-stabilized polyvinyl esters in the form of aqueous dispersions as claimed in claim 17, characterized in that the proportion of the polyvinyl alcohols α) is 0.5% to 5% by weight, based on the dry weight of the polyvinyl esters.

20. The polyvinyl alcohol-stabilized polyvinyl esters in the form of aqueous dispersions as claimed in claim 16, characterized in that at least one polyvinyl alcohol (polyvinyl alcohol β)) has a viscosity of 19 to 30 mPas.

21. The polyvinyl alcohol-stabilized polyvinyl esters in the form of aqueous dispersions as claimed in claim 20, characterized in that the proportion of the polyvinyl alcohols β) is 30% to 70% by weight, based on the total weight of the polyvinyl alcohols present in the polyvinyl ester dispersion.

22. The polyvinyl alcohol-stabilized polyvinyl esters in the form of aqueous dispersions as claimed in claim 20, characterized in that the proportion of the polyvinyl alcohols β) is 0.5% to 5% by weight, based on the dry weight of the polyvinyl esters.

23. The polyvinyl alcohol-stabilized polyvinyl esters in the form of aqueous dispersions as claimed in claim 16, characterized in that one or more polyvinyl esters are selected from the group comprising vinyl ester homopolymers, vinyl ester-ethylene copolymers, vinyl ester copolymers containing one or more vinyl ester units and one or more further monomer units from the group comprising vinylaromatics, vinyl halides, acrylic esters, methacrylic esters, and optionally ethylene.

24. The polyvinyl alcohol-stabilized polyvinyl esters in the form of aqueous dispersions as claimed in claim 16, characterized in that the polyvinyl esters in the form of aqueous dispersions, at a solids content of 53%, have a viscosity of 4000 to 12 000 mPas (determined with a Brookfield viscometer, at 23° C. and 20 rpm).

25. Processes for preparing polyvinyl esters in the form of aqueous dispersions by free-radically initiated emulsion polymerization of a) one or more vinyl esters and optionally b) one or more further ethylenically unsaturated monomers in aqueous medium in the presence of at least two polyvinyl alcohols in the absence of emulsifiers, characterized in that all polyvinyl alcohols have a degree of hydrolysis of 80 to 94 mol % and a viscosity from the range of 8 to 30 mPas and at least two polyvinyl alcohols differ in their viscosity,
where the viscosity of the polyvinyl alcohols is determined at 20° C. in 4% aqueous solution according to Höppler in accordance with DIN 53015.

26. The processes for preparing polyvinyl esters in the form of aqueous dispersions as claimed in claim 25, characterized in that one or more emulsifiers are added after the emulsion polymerization has been carried out.

27. Dispersion adhesives containing one or more polyvinyl alcohol-stabilized polyvinyl esters in the form of aqueous dispersions as claimed in claim 16, one or more additives, and water,
with the proviso that the additives are selected from the group consisting of plasticizers, triacetin, thickeners and tackifiers.

28. Processes for applying dispersion adhesives containing one or more polyvinyl alcohol-stabilized polyvinyl esters in the form of aqueous dispersions, one or more additives and water by machine application methods, characterized in that the polyvinyl alcohol-stabilized polyvinyl esters are prepared in the form of aqueous dispersions by the processes of claim 25.

29. Processes for applying dispersion adhesives containing one or more polyvinyl alcohol-stabilized polyvinyl esters in the form of aqueous dispersions, one or more additives and water by machine application methods, characterized in that the polyvinyl alcohol-stabilized polyvinyl esters are prepared in the form of aqueous dispersions by the processes of claim 26.
